(19) United States
(12) Patent Application Publication
(10) Pub. No.: US 2010/0043038 A1
(43) Pub. Date: Feb. 18, 2010

(54) SYSTEM AND METHOD FOR EFFICIENT VIDEO AND AUDIO INSTANT REPLAY FOR DIGITAL TELEVISION

(75) Inventor: Xin Li, Fremont, CA (US)

Correspondence Address: Lando & Anastasi, LLP;Z2002, One Main Street, Suite 1100, Cambridge, MA, 02142, US

(73) Assignee: Zoran Corporation, Sunnyvale, CA (US)

(21) Appl. No.: 12/537,438

(22) Filed: Aug. 7, 2009

Related U.S. Application Data
(60) Provisional application No. 61/088,816, filed on Aug. 14, 2008.

(51) Int. Cl. H04N 5/44; H04N 7/173

(52) U.S. Cl. 725/103; 348/559; 348/E05.101

(57) ABSTRACT

A digital television system that includes an RF tuner, a transport stream demultiplexer, an audio decoder, a video decoder, a non-persistent memory, and at least one processor. The non-persistent memory is used to store audio and video packetized elementary stream (PES) packets demultiplexed by the transport stream demultiplexer based upon a broadcast signal received and demodulated by the RF tuner. During the process of decoding and presenting audio, video, and audio-video content on a display device of the television system, the at least one processor generates video records corresponding to each video PES packet and audio records corresponding to each audio PES packet. The video and audio records establish a one to one correspondence between each video PES packet and each audio PES packet and permits each video PES packet and each audio PES packet stored in the memory to be located, decoded, and re-displayed on the display device on the television system.

### CROSS REFERENCE TO RELATED APPLICATIONS

This application claims priority under 35 U.S.C. 119(e) to U.S. Provisional Application Ser. No. 61/088,816 entitled “Efficient Implementation of Video and Audio Instant Replay for Digital Television” filed on Aug. 14, 2008, which is incorporated herein by reference in its entirety.

### BACKGROUND OF THE INVENTION

1. Field of the Invention

The present invention is generally directed to digital television systems, and more particularly to a method and system for efficient video and/or audio instant replay in a digital television system.

2. Discussion of the Related Art

A digital video recorder (DVR) or personal video recorder (PVR) is an electronic device that is capable of storing video and/or audio content in a digital format to a disk drive or other type of memory within the device. Once the video and/or audio content is stored or recorded, it may be replayed, as desired by a user of the device. Most DVRs or PVRs are implemented either as a standalone device, or within a standalone device, such as a set-top box, a computer, or other type of media player. However, some consumer electronic manufactures have implemented the functionality of a DVR or PVR within a television system itself. In general, such television systems generally include a large amount of additional memory (i.e., in addition to that required to display digital video and audio content received over a broadcast medium or from another device), such as a hard disk drive or RAM, to store the digital video and/or audio content, as well as other additional hardware to permit the stored digital video and/or audio content to be located and played back for the user. Such additional memory and hardware add to the expense of the television system. Further, although the stored video and/or audio content may be replayed, as desired by the user, the ability to replay the stored video and/or audio content, as conventionally implemented, is not instantaneous, as it generally takes an appreciable amount of time to locate the stored content and format it for presentation to the user.

### SUMMARY OF THE INVENTION

Embodiments of the present invention are generally directed to a digital television system in which video and/or audio content that has been presented to a user may be replayed in a cost-effective and nearly instantaneous manner. Thus, for example, if a user is watching a baseball game on their television system, and wishes to replay an interesting scene, such as a home run or a close play at home plate, the user may replay that scene in a nearly to instantaneous manner as desired.

In accordance with one aspect of the present invention, a method of processing a broadcast signal that includes at least one of audio data and video data is provided. The method comprises acts of demodulating the broadcast signal to provide transport stream packets corresponding to the broadcast signal; demultiplexing the transport stream packets to provide a plurality of packetized elementary stream packets and decoding and presentation timing information corresponding to each of the plurality of packetized elementary stream packets; storing the plurality of packetized elementary stream packets in a volatile memory; decoding the plurality of packetized elementary stream packets stored in the volatile memory based upon the decoding timing information; presenting the decoded plurality of packetized elementary stream packets on a display device based upon the presentation timing information; generating a plurality of records corresponding to each of the plurality of packetized elementary stream packets and storing the plurality of records in the volatile memory, each of the plurality of records identifying a location of a respective one of the plurality of packetized elementary stream packets stored in the volatile memory and the decoding and presentation timing information corresponding to the respective one of the plurality of packetized elementary stream packets; locating a first of the plurality of packetized elementary stream packets stored in the volatile memory based upon an instruction to replay at least one of the plurality of packetized elementary stream packets stored in the volatile memory; decoding, subsequent to the act of presenting, the first of the plurality of packetized elementary stream packets stored in the volatile memory based upon the record corresponding to the first of the plurality of packetized elementary stream packets, the first of the plurality of elementary stream packets, and the decoding timing information corresponding to the first of the plurality of packetized elementary stream packets; and re-presenting the decoded first of the plurality of packetized elementary stream packets on the display device based upon the presentation timing information corresponding to the first of the plurality of packetized elementary stream packets.

In one embodiment, where the broadcast signal includes both audio and video data, the act of demultiplexing includes demultiplexing the transport stream packets to provide a plurality of video packetized elementary stream packets and decoding and presentation timing information corresponding each of the plurality of video packetized elementary stream packets and to provide a plurality of audio packetized audio packetized elementary stream packets and decoding and presentation timing information corresponding each of the plurality of audio packetized elementary stream packets.

In accordance with another aspect of the present invention, a digital television system is provided. The digital television system comprises an RF tuner to receive a broadcast signal, demodulate broadcast signal, and provide transport stream packets corresponding to the broadcast signal; a transport stream demultiplexer, a non-persistent memory, at least one decoder, a display device, and at least one processor. The transport stream demultiplexer is coupled to the RF tuner to receive the transport stream packets, demultiplex the transport stream packets, and provide a plurality of packetized elementary stream packets and decoding and presentation timing information corresponding to each of the plurality of packetized elementary stream packets. The non-persistent memory is coupled to the transport stream demultiplexer, and has a plurality of memory regions including a first memory region configured to store the plurality of packetized elementary stream packets, and a second memory region configured to store a plurality of records corresponding to each of the plurality of packetized elementary stream packets. The at least one decoder is coupled to transport stream demultiplexer and the non-persistent memory to decode the plurality of packetized elementary stream packets according to the decoding timing information corresponding to each of the plurality of packetized elementary stream packets. The display device is configured to present the plurality of decoded packetized elementary stream packets according to the presentation timing information corresponding to each of the plurality of decoded packetized elementary stream packets. The at least one processor is coupled to the non-persistent memory and the at least one decoder. The at least one processor executes a set of instructions configured to generate the plurality of records corresponding to each of the plurality of packetized elementary stream packets, each of the plurality of records identifying a location of a respective one of the plurality of packetized elementary stream packets stored in the first memory region and the decoding and presentation timing information corresponding to the respective one of the plurality of packetized elementary stream packets; locate a first of the plurality of packetized elementary stream packets stored in the first memory region and corresponding to a previously decoded and displayed packetized elementary stream packet responsive to an instruction to replay at least one of the plurality of packetized elementary stream packets; decode the first of the plurality of packetized elementary stream packets based upon the record corresponding to the first of the plurality of packetized elementary stream packets, the first of the plurality of packetized elementary stream packets, and the decoding timing information corresponding to the first of the plurality of packetized elementary stream to packets; and re-present the first of the decoded packetized elementary stream packets on the display device based upon the presentation timing information corresponding to the first of the plurality of packetized elementary stream packets.

In accordance with one embodiment, the first memory region includes a video buffer region configured to store a plurality of video packetized elementary stream packets and an audio buffer region configured to store a plurality of audio packetized elementary stream packets. In this embodiment, the second memory region includes a video record buffer region configured to store a plurality of video records corresponding to each of the plurality of video packetized elementary stream packets and an audio record buffer region configured to store a plurality of audio records corresponding to each of the plurality of audio packetized elementary stream packets, each video record of the plurality of video records identifying a location, in the video buffer region, where a respective one of the plurality of video packetized elementary stream packets is stored, and the decoding and presentation timing information corresponding to the respective one of the plurality of video packetized elementary stream packets, and each audio record of the plurality of audio records identifying a location, in the audio buffer region, where a respective one of the plurality of audio packetized elementary stream packets is stored, and the decoding and presentation timing information corresponding to the respective one of the plurality of audio packetized elementary stream packets.

In accordance with one embodiment, the at least one decoder includes a video decoder and an audio decoder. The video decoder is coupled to transport stream demultiplexer and the non-persistent memory to decode the plurality of video packetized elementary stream packets according to the decoding timing information corresponding to each of the plurality of video packetized elementary stream packets. The audio decoder is coupled to transport stream demultiplexer and the non-persistent memory to decode the plurality of audio packetized elementary stream packets according to the decoding timing information corresponding to each of the plurality of audio packetized elementary stream packets.

In accordance with a further embodiment, the digital television system further comprises a display processor, coupled to the video decoder and the display device, to display the plurality of decoded video packetized elementary stream packets on the display device, and an audio digital to analog converter, coupled to the audio decoder and the display device, to convert the plurality of decoded audio packetized elementary stream packets to an analog format for presentation on an audio output device associated with the display device. In accordance with a further aspect of this embodiment, the RF tuner, the transport stream to demultiplexer, the non-persistent memory, the video decoder, the audio decoder, the display processor, the audio digital to analog converter, and the at least one processor are implemented on a same integrated circuit.

### BRIEF DESCRIPTION OF THE DRAWINGS

Various aspects of at least one embodiment are discussed below with reference to the accompanying figures, which are not intended to be drawn to scale. In the figures, each identical or nearly identical component that is illustrated in various figures is represented by a like numeral. For purposes of clarity, not every component may be labeled in every figure. In the drawings:

FIG. 1 is a conceptual diagram illustrating the architecture of a digital television system in accordance with embodiments of the present invention;

FIG. 2 graphically illustrates the organization of the various data structures used to implement replay functionality in accordance with one embodiment of the present invention;

FIG. 3 is a data flow diagram of a television system controller that may be used in a television system in accordance with an embodiment of the present invention;

FIG. 4 illustrates a task structure that may be implemented by the television system controller 300 in accordance with an embodiment of the present invention;

FIG. 5 is a flow chart depicting acts that are performed during the replay mode of operation by an instant replay routine in accordance with an embodiment of the present invention;

FIG. 6 graphically illustrates the manner in which VFR records and video PES packets are identified during the replay process in accordance with an embodiment of the present invention;

FIG. 7a illustrates the manner in which the System Time Clock may be represented;

FIG. 7b illustrates the manner in which the decoding and presentation of audio data may be synchronized to the decoding and presentation of video data in accordance with an embodiment of the present invention; and

FIG. 8 illustrates a trick mode control unit that can re-order frames in a Group of Pictures so that they may be decoded and displayed in a number of different trick modes.

### DETAILED DESCRIPTION

The systems and methods described herein are not limited in their application to the details of construction and the arrangement of components set forth in the description or illustrated in the drawings. The invention is capable of other embodiments and of being practiced or of being carried out in various ways. Also, the phraseology and terminology used herein is for the purpose of description and should not be regarded as limiting. The use of “including” “comprising” “having” “containing” “involving” and variations thereof herein, is meant to encompass the items listed thereafter and equivalents thereof as well as additional items.

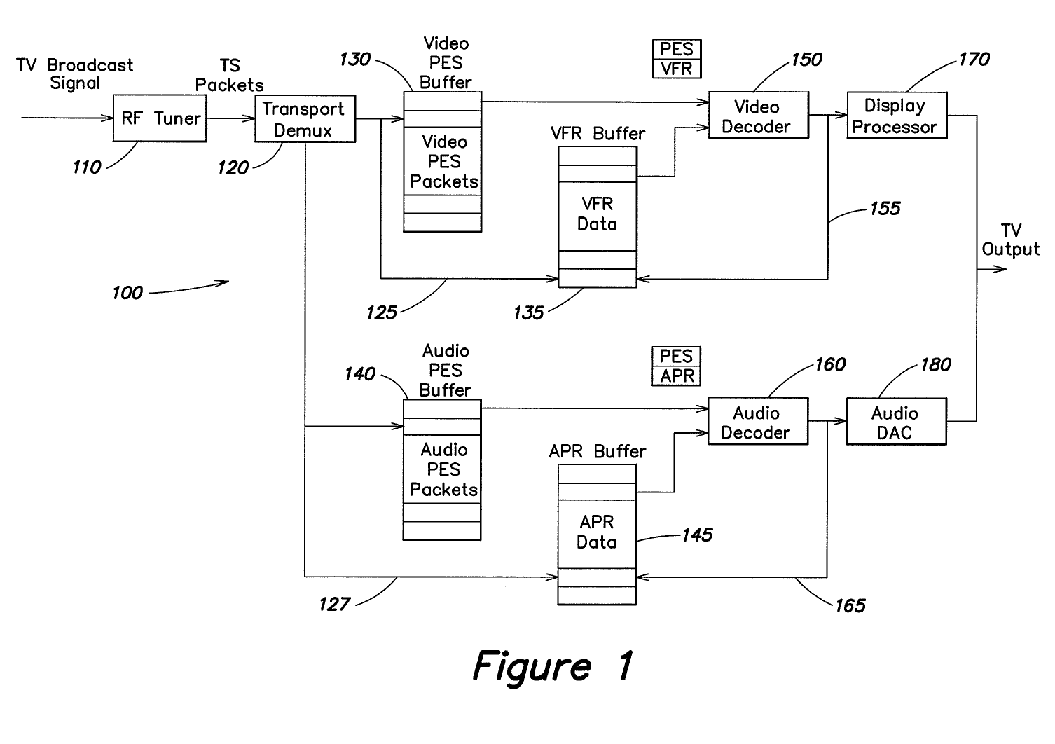

FIG. 1 is a conceptual diagram illustrating the architecture of a digital television system in accordance with embodiments of the present invention. The digital television system 100 includes a digital RF tuner 110 to receive a digital television broadcast signal from a broadcast medium (not shown), to demodulate the television broadcast signal, and to convert the television broadcast signal into a transport stream (TS) format in a well known manner. Transport stream (TS) packets provided by the digital RF tuner 110 are received by a transport stream demultiplexer 120 that demultiplexes the TS packets into separate video and audio packetized elementary stream (PES) packets in a well known manner. The video and audio PES packets are then typically stored in a respective video PES buffer 130 and an audio PES buffer 140, typically allocated from some form of on-board double data rate (DDR) memory. During normal operation, and in a conventional manner, video PES packets are removed from the video PES buffer 130 and decoded by a video decoder 150 according to the decoding time stamp (DTS) of the video PES packets. The decoded video content is then provided to a display processor 170 based upon the presentation time stamp (PTS) associated with the video PES packet from which the decoded video content was obtained. The display processor 170 then displays the decoded video content on a display device, such as an LCD display or a plasma display (not shown) in well known manner. Audio PES packets are similarly removed from the audio PES buffer 140 and decoded in a well known manner by an audio decoder 160 that decodes the audio PES packets according to the decoding time stamp (DTS) of the audio PES packets, and provides the decoded audio content to an audio digital to analog converter (DAC) 180 according to the presentation time stamp (PTS) associated with the audio PES packet from which the decoded audio content was obtained. The audio DAC 180 converts the to decoded digital audio content into an analog form and provides analog signals to an output device, such as one or more speakers associated with the display device.

In accordance with an aspect of the present invention, during the reception, decoding, and presentation of video and/or audio content received from a digital television broadcast medium, additional information pertaining to the video and/or audio PES packets stored in the video PES buffer 130 and the audio PES buffer 140 may be generated. This additional information allows video and/or audio content contained in the video and/or audio PES buffers 130, 140 to be quickly located, and includes all the information needed to decode and replay that video and/or audio content. In accordance with an embodiment of the present invention, additional information corresponding to each video PES packet stored in the video PES buffer 130 is stored in a respective video frame record (VFR) of a video frame record (VFR) buffer 135, and additional information corresponding to each audio PES packet stored in the audio PES buffer 140 is stored in a respective audio packet record (APR) of an audio packet record (APR) buffer 145. This additional information establishes a one to one correspondence between each VFR stored in the VFR buffer 135 and each video PES packet stored in the video PES buffer 130 and between each APR stored in the APR buffer 145 and each audio PES packet stored in the audio PES buffer 140 and includes all the information needed locate, decode, and present the video and/or audio content stored in the PES buffers 130, 140.

In accordance with an aspect of the present invention, each of the video PES buffer 130, the audio PES buffer 140, the VFR buffer 135 and the APR buffer 145 may be implemented as circular buffers allocated from a volatile or non-persistent form of memory, such as RAM. For example, when a new video PES packet is stored in the video PES buffer 130, the oldest video PES packet in the buffer may be replaced by the new video PES packet. During the demultiplexing and storage of the new video PES packet, a new VFR corresponding to that video PES packet is generated and stored in the VFR buffer 135, replacing the oldest VFR in the VFR buffer, and maintaining the one to one correspondence between each VFR stored in the VFR buffer 135 and its corresponding video PES packet stored in the video PES buffer 130. The audio PES buffer 140 and the APR buffer 145 operate in a similar manner.

In accordance with an aspect of the present invention, and in contrast to conventional digital television systems, during the decoding and presentation process, the additional information stored in the VFR buffer 135 and the APR buffer 145, as well as video PES packets and audio PES packets stored in the video and audio PES buffer 130, 140 are to preserved in their respective buffers until the respective buffers become full. Should the user decide to replay certain video or audio content, the television system can quickly locate, decode, and present any video or audio content contained in the video or audio PES buffers 130, 140 based upon the information stored in the VFR and APR buffers 135, 145 and the one to one correspondence between the VFRs and APRs stored in the VFR and APR buffers 135, 145 and their corresponding video and audio PES packets stored in the video PES buffer 130 and the audio PES buffer 140. By preserving the VFRs and APRs within their respective buffers, little additional memory, and no additional hardware is needed to replay any video or audio content stored within the video and audio PES buffers 130, 140, except for the relatively small amount of memory needed to store the VFRs and APRs. For example, in one implementation, the additional amount of memory needed to stored the VFRs and APRs corresponding to two minutes of combined audio-video content is approximately 210 Kbytes.

In accordance with an aspect of the present invention, the television system supports different modes of operation including a normal mode of operation in which a digital television broadcast signal is received, demodulated, demutliplexed, and decoded, and the decoded video and/or audio content is presented to a user of the television system in a conventional manner, and a replay mode of operation. In the replay mode of operation, in addition to demodulating the digital television broadcast signal, demultiplexing the TS packets, decoding the video and/or audio PES packets and presenting the video and/or audio content to the user, the television system generates and stores additional information allowing the user to replay previously presented content, in the manner it was previously presented, or in a number of trick modes, such as fast forward, slow forward, stop/pause, fast backward, slow backward, single step forward, single step backward, etc. During the instant replay mode, the video and/or audio content may be replayed as many times as desired by the user. This replay mode of operation is now described with respect to FIG. 1.

As in the normal mode of operation, the digital RF tuner 110 receives a digital television broadcast signal, demodulates the television broadcast signal, and converts the demodulated television broadcast signal into a transport stream (TS) format in a conventional manner TS packets provided by the digital RF tuner 110 are received by the transport stream demultiplexer 120 that demultiplexes the TS packets into separate video and audio packetized elementary stream (PES) packets in a conventional manner, and stores the video and audio PES packets in a respective PES buffer. However, during the replay mode of operation, as the to TS packets are demultiplexed by the transport stream demultiplexer 120, additional information in the form of VFRs and APRs is generated, as depicted in FIG. 1 by arrows 125 and 127, respectively. In general, each VFR includes information that permits a video frame stored in the Video PES buffer 130 to be located and decoded by the video decoder 150, including information identifying, the type of video frame, such as an I-frame (an Intra-coded frame or picture), a P-frame (a Predicted frame or picture), or a B-frame (a Bi-directionally predicted frame or picture), timing information for video decoding and display such as PTS, DTS, etc, and buffer related information, such as pointers identifying the location of various information in the video PES packet, the number of video data bytes in the frame, etc. Each APR includes similar information, such as timing information for audio decoding and display, such as PTS, DTS, etc. and buffer related information, such as pointers identifying the location of various information in the audio PES packet, the number of audio data bytes in the audio packet, etc.

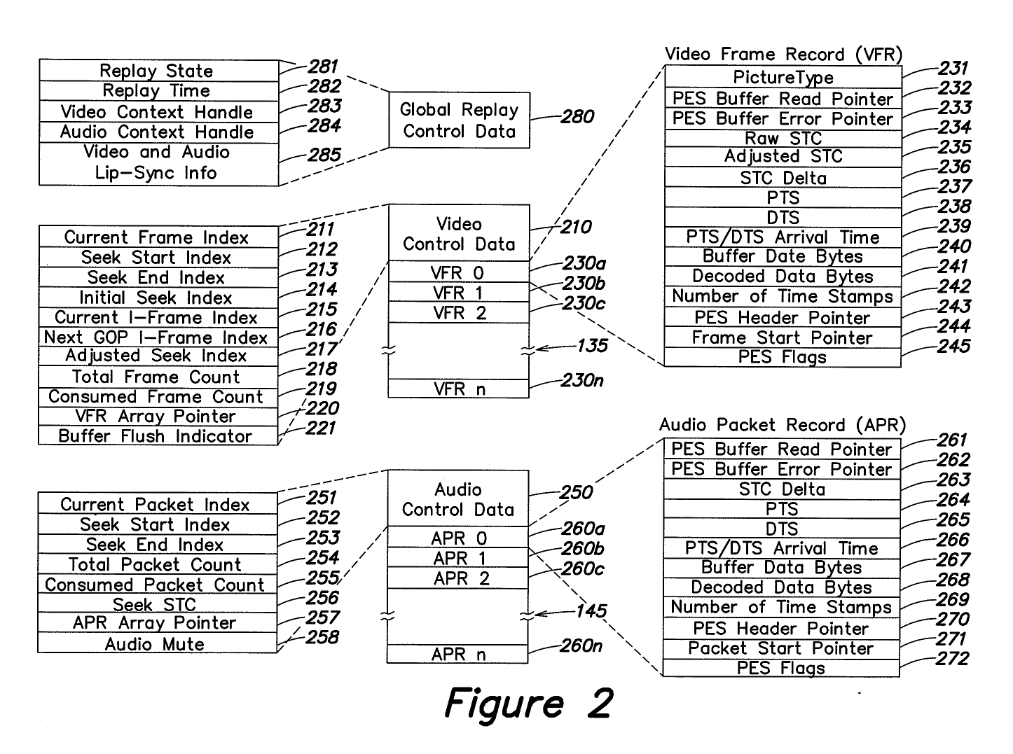

FIG. 2 graphically illustrates the organization of the various data structures used to implement replay functionality, including the various fields of information that are stored in the VFR buffer 135 and the APR buffer 145 in accordance with one embodiment of the present invention. As depicted in FIG. 2, the VFR buffer 135 includes a Video Control Data structure 210 and a plurality of Video Frame Records (VFRs) 230a, 230b, 230c . . . 230n. As described more fully below, the Video Control Data structure 210 includes information about a current frame for which a VFR is being generated, and control data that permits video content contained in a video PES packet to be quickly located for replay. Each of the VFRs 230 are stored in a circular buffer, such that the VFR 0 corresponds to the oldest VFR in the VFR buffer 135 and VFRn corresponds to the most recent record in the VFR buffer 135. Each VFR 230 stored in the VFR buffer 135 corresponds to a video PES packet stored in the video PES buffer 130 and includes all the information needed to decode and present the video content stored in the corresponding video PES packet at a later time.

Each VFR 230 may include the following fields of information: a Picture Type field 231, a PES Buffer Read Pointer field 232, a PES Buffer Error Pointer field 233, a Raw STC (System Time Clock) field 234, an Adjusted STC field 235, an STC Delta field 236, a PTS field 237, a DTS field 238, a PTS/DTS Arrival Time field 239, a Buffer Data Bytes field 240, a Decoded Data Bytes field 241, a Number of Time Stamps field 242, a PES Header Pointer field 243, a Frame Start Pointer field 244, and a PES Flags field 245. It should be appreciated that certain of the information stored in each VFR, such as the Raw STC, the Adjusted STC, to the STC Delta, and the Decoded Data Bytes may be obtained from the video decoder 150 during the decoding of a particular video PES packet, as depicted by arrow 155. This information, obtained from the video decoder 150 is typically not preserved during a conventional decoding process, but permits embodiments of the present invention to later decode and present previously presented video content. A detailed description of the information that is included in each VFR 230 is provided in Table 1 below.

TABLE 1
Video Frame Record (VFR)

| FIELD | DESCRIPTION |
|---|---|
| Picture Type: | Identifies frame type (I, P, or B). |
| PES Buffer Read Pointer: | Points to location in Video PES Buffer where Video PES |
| | packet corresponding to this frame is stored. |
| PES Buffer Error Pointer: | Points to location of the first error in frame, if any. |
| Raw STC: | Decoder's current Raw STC (System Time Clock) |
| | captured when this video frame is to be decoded based on |
| | 27 MHz clock. |
| Adjusted STC: | Decoder's current STC adjusted based on Raw STC and |
| | STC Delta to be comparable with PTS and DTS. |
| STC Delta: | Difference between the decoder RAW STC and the PCR |
| | (Program Clock Reference) at the time the video frame |
| | should be decoded. |
| PTS: | Time at which video frame is to be presented based on 90 |
| | KHz clock. |
| DTS: | Time at which video frame is to be decoded based on 90 |
| | KHz clock. |
| PTS/DTS Arrival Time: | Time according to Raw STC of decoder when the |
| | PTS/DTS of the video frame is received. |
| Buffer Data Bytes: | Total number of video data bytes in Video PES buffer at |
| | the time this frame is to be decoded. |
| Decoded Data Bytes: | Number of video data bytes corresponding to this frame |
| | when decoded. |
| Number of Time Stamps: | Total umber of time stamps (e.g., PTS, DTS) contained in |
| | the Video PES Buffer at the time this frame is to be |
| | decoded. |
| PES Header Pointer: | Points to location in Video PES Buffer where header of |
| | Video PES packet corresponding to this frame is stored. |
| Frame Start Pointer: | Points to location in Video PES Buffer where video data |
| | of the Video PES packet corresponding to this frame is |
| | stored. |
| PES Flags: | A set of flags that indicate the Video PES packet |
| | properties (e.g., whether a PTS or DTS corresponding to |
| | this frame is contained in this Video PES packet). |

The Video Control Data structure 210 includes a plurality of fields 211-221 that include information about a current video PES packet, for which a VFR is being generated, as well as other information that permits frames of video content to be located and provided to the video decoder 150 for playback. Information relating to a current video PES packet includes a Current Frame Index field 211 and a Total Frame Count field 218. Information that is included in the Video Control Data structure 210 that is used to permit a user to locate and play back previously viewed video content includes a Seek Start Index field 212, a Seek End Index field 213, an Initial Seek Index field 214, a Current I-Frame Index field 215, a Next GOP (Group of Pictures) I-Frame Index field 216, an Adjusted Seek Index field 217, a Consumed Frame Count field 219, a VFR Array Pointer field 220, and a Buffer Flush Indicator field 221. A detailed description of the information that is included in the Video Control Data structure 210 is provided in Table 2 below.

TABLE 2
Video Control Data

| FIELD | DESCRIPTION |
|---|---|
| Current Frame Index: | Index of the frame for which we are generating VFR |
| | record. |
| Seek Start Index: | Index of the oldest VFR record in VFR buffer when seek |
| | starts. |
| Seek End Index: | Index of most recent VFR record in VFR buffer when |
| | seek starts. |
| Initial Seek Index: | Index of the VFR record calculated based on replay time |
| | and frame rate. |
| Current I-Frame Index: | Index of the Current GOP starting I-frame which contains |
| | the initial seek index. |
| Next GOP I-Frame index: | Index of next GOP starting I-frame after the Current GOP |
| | starting I-frame. |
| Adjusted Seek Index: | Either the Current I-frame Index or the Next GOP I-frame |
| | index, depending on which is closer and whether one has |
| | an error. |
| Total Frame Count: | Number of frames in Video PES buffer. |
| Consumed Frame Count: | Number of video frames that have been replayed. |
| VFR Array Pointer: | Pointer to the VFR array. |
| Buffer Flush Indicator: | Whether replay buffers should be flushed when going |
| | back to normal play mode. |

As depicted in FIG. 2, the organization and structure of the APR buffer 145 is similar to the organization and structure of the VFR buffer 135. The APR buffer 145 includes an Audio Control Data structure 250 and a plurality of Audio Packet Records (APR) 260a, 260b, 260c . . . 260n. As described more fully below, the Audio Control Data structure 250 includes information about a current audio packet for which an APR is being generated, and control data that permits audio content contained in an audio PES packet to be quickly located for replay. The APRs 260 are stored in a circular buffer, such that the APR 0 corresponds to the oldest APR in the APR buffer 145 and APRn corresponds to the most recent record in the APR buffer 145. Each APR 260 corresponds to an audio PES packet stored in the audio PES buffer 140 and includes all the information needed to decode and present the audio content stored in the corresponding audio PES packet at a later time.

Each APR 260 may include the following fields of information: a PES Buffer Read Pointer field 261, a PES Buffer Error Pointer field 262, an STC Delta field 263, a PTS field 264, a DTS field 265, a PTS/DTS Arrival Time field 266, a Buffer Data Bytes field 267, a Decoded Data Bytes field 268, a Number of Time Stamps field 269, a PES Header Pointer field 270, a Packet Start Pointer field 271, and a PES Flags field 277. As with the VFR, certain information stored in each APR, such as the STC Delta and the Decoded Data Bytes may be to obtained from the audio decoder 160 during the decoding of a particular audio PES packet, as depicted by arrow 165. This information, obtained from the audio decoder 160 is typically not preserved during a conventional decoding process, but permits embodiments of the present invention to later decode and present previously presented audio content. A detailed description of the information that is included in each APR 260 is provided in Table 3 below.

TABLE 3
Audio Packet Record (APR)

| FIELD | DESCRIPTION |
|---|---|
| PES Buffer Read Pointer: | Points to location in Audio PES buffer where Audio PES |
| | packet corresponding to this audio packet is stored. |
| PES Buffer Error Pointer: | Points to location of the first error in audio packet, if any. |
| STC Delta: | Difference between the decoder Raw STC and the PCR at |
| | the time the audio packet should be decoded. |
| PTS: | Time at which audio packet is to be presented based on 90 |
| | KHZ clock. |
| DTS: | Time at which audio packet is to be decoded based on 90 |
| | KHz clock. |
| PTS/DTS Arrival Time: | Time according to Raw STC of decoder when PTS/DTS |
| | of the audio packet is received. |
| Buffer Data Bytes: | Total number of audio data bytes in Audio PES buffer at |
| | the time this audio packet is to be decoded. |
| Decoded Data Bytes: | Number of audio data bytes corresponding to this audio |
| | packet when decoded. |
| Number of Time Stamps: | Total number of time stamps contained in the Audio PES |
| | buffer at the time this audio packet is to be decoded. |
| PES Header Pointer: | Points to location in Audio PES buffer where header of |
| | Audio PES packet corresponding to this audio packet is |
| | stored. |
| Packet Start Pointer: | Points to location in Audio PES buffer where audio data |
| | of the Audio PES packet corresponding to this audio |
| | packet is stored. |
| PES Flags: | A set of flags that indicate the Audio PES packet |
| | properties (e.g., whether a PTS or DTS corresponding to |
| | this audio packet is contained in this Audio PES packet). |

The Audio Control Data structure 250 includes a plurality of fields 251-258 that include information about a current audio PES packet, for which an APR is being generated, as well as other information that permits packets of audio content to be located and provided to the audio decoder 160 for playback. Information relating to a current audio PES packet includes a Current Packet Index field 251 and a Total Packet Count field 255. Information that is included in the Audio Control Data structure 250 that is used to permit a user to locate and to play back previously viewed audio content includes a Seek Start Index field 252, a Seek End Index field 253, a Consumed Packet Count field 255, a Seek STC field 256, an APR Array Pointer field 257, and an Audio Mute field 258. A detailed description of the information that is included in the Audio Control Data structure 250 is provided in Table 4 below.

TABLE 4
Audio Control Data

| FIELD | DESCRIPTION |
|---|---|
| Current Packet Index: | Index of audio packet for which we are generating APR |
| | record. |
| Seek Start Index: | Index of the oldest APR record in APR buffer when seek |
| | starts. |
| Seek End Index: | Index of most recent APR record in APR buffer when |
| | seek starts. |
| Total Packet Count: | Number of audio packets in Audio PES buffer. |
| Consumed Packet Count: | Number of audio packets that have been replayed. |
| Seek STC: | STC value calculated based on the audio replay time for |
| | initial seek position. |
| APR Array Pointer: | Pointer to APR array. |
| Audio Mute: | Whether to mute audio. |

In accordance with an embodiment of the present invention, the replay mode of operation includes three distinct states of operation including a STORE state, a SEEK state, and a RETRIEVE state. The STORE state generates and preserves the VFRs and APRs in the VFR buffer 135 and the APR buffer 145. The SEEK state locates the VFR and APR corresponding to the desired starting position identified by the user for playback, and the RETRIEVE state obtains the VFR and APR data from the respective VFR and APR buffers to 135, 145 and sends that information, along with their corresponding video and audio PES packets, to the decoders. Control information relating to the state of operation during the replay mode and which enables instant replay functionality to be realized may be stored in a Global Replay Control Data structure 280, as depicted in FIG. 2.

As shown in FIG. 2, the Global Replay Control Data structure 280 includes a Replay State field 281 that identifies whether the system is in a STORE state, a SEEK state, or a RETRIEVE state, a Replay Time field 282 that identifies the time, in seconds that the user desires to replay, a Video Context Handle field 283, an Audio Context Handle field 284, and a Video and Audio Lip-Sync Information field 285. The Video Context Handle field 283 is a handle (or pointer) to a complex video decoding data structure that contains detailed information about how to decode this video frame in normal play mode. Such a video context handle is used in a conventional video decoding process, as well as during the replay mode of operation and includes frame-specific decoding information such as whether the current video frame is a frame picture or a field picture, whether it is a 30 Hz frame or a 29.97 Hz frame, etc., frame buffer information, such as where video frames are stored after being decoded, etc. The Audio Context Handle field 284 is an analogous handle (or pointer) to a complex audio decoding data structure that contains detailed information about how to decode this audio packet in normal play mode as well as in the replay mode of operation. The Video and Audio Lip-Sync Information field 285 includes video and audio phase information that is used to synchronize the presentation of video and audio content during playback.

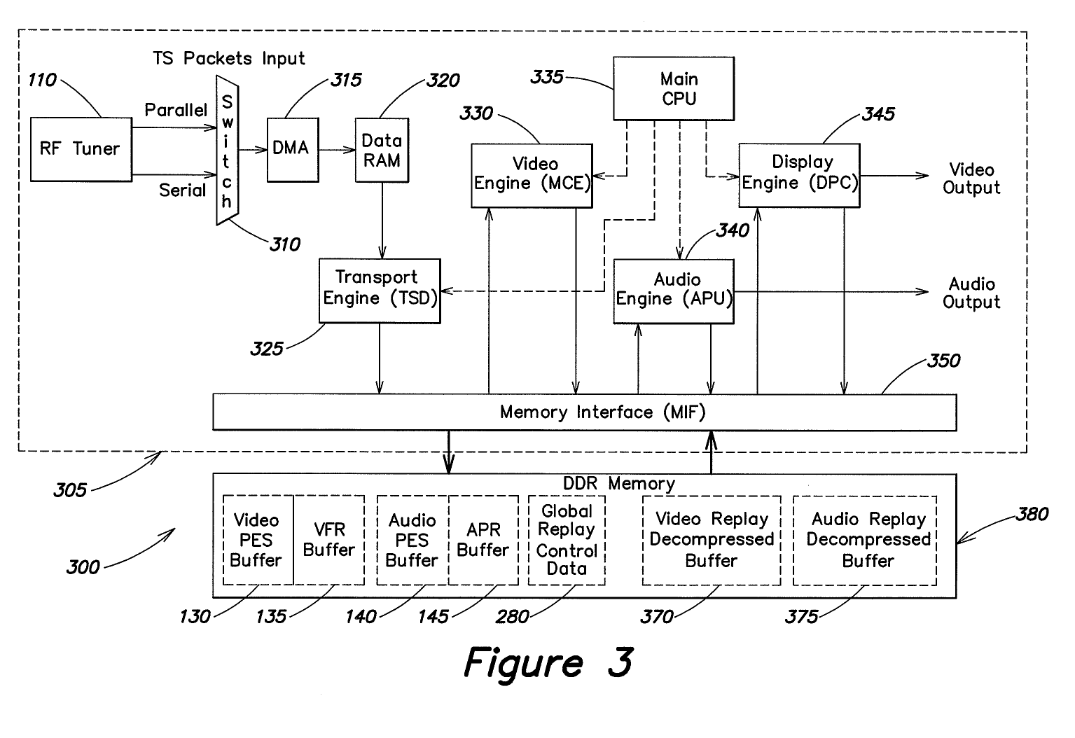

FIG. 3 is a data flow diagram of a television system controller that may be used in a television system in accordance with an embodiment of the present invention. The television system controller 300 includes a main CPU 335, a transport engine 325, a video engine 330, an audio engine 340, and a display engine 345. The main CPU 335 may, for example, be based upon a MIPS CPU available from MIPS Technologies, Inc. of Sunnyvale Calif., and each of the transport engine 325, the video engine 330, the audio engine 340, and the display engine 345 may be microprocessor-based microcontrollers, each with their own registers and programmed sets of instructions adapted to perform lower level tasks, such as transport stream demultiplexing, video and audio decoding and display, etc. as directed by the main CPU 335. In accordance with one embodiment, the functionality of the video decoder 150 described previously with respect to FIG. 1 is implemented in code that is executed on the microcontroller of the video engine 330, and the functionality of the audio decoder 160 described previously with respect to FIG. 1 is implemented in code that is executed on an audio microcontroller or a DSP (Digital Signal Processor) of the audio engine 340. The audio engine 340 may include an audio DAC 180 (see FIG. 1) to generate analog audio output signals to be provided to an audio presentation device, such as one or more speakers. The functionality of the transport stream demultiplexer 120 described previously with respect to FIG. 1 is implemented in code that is executed on the microcontroller of the transport engine 325, and the functionality of display processor 170 described previously with respect to FIG. 1 is implemented in code that is executed on a microcontroller of the display engine 345.

Each of the transport engine 325, the video engine 330, the audio engine 340 and the display engine 345 is coupled to a high speed memory interface 350 through which they communicate with DDR memory 380. During system initialization, portions of the DDR memory 380 are allocated to form the video PES buffer 130, the VFR buffer 135, the Audio PES buffer 140, the APR buffer 145, and the Global Replay Control Data structure 280. Other portions of the DDR memory 380 are allocated as buffers 370 and 375 to store decompressed audio and video data for presentation to a user during the replay mode of operation, as well as during “trick” modes of operation. As described more fully below, during trick modes of operation, such as single-step rewind, more memory may be needed to store decoded I and P-frames in a Group of Pictures (GOP) to enable the frames of the GOP to be decoded and presented to the user in an order different from their original frame order.

The television system controller 300 further includes an RF Tuner 110 coupled to a switch 310, a DMA controller 315 coupled to the switch 310 and an internal RAM memory 320. The internal RAM memory 320 is coupled to the transport engine 325. During operation, and as described previously with respect to FIG. 1, the RF tuner 110 demodulates the digital television broadcast signal received over a broadcast medium (not shown) and converts the television broadcast signal into TS packets in a conventional manner The TS packets may be to provided to the switch 310 in either parallel format or serial format. The DMA controller 315 receives the TS packets and stores them in the internal RAM memory 320 where they can be processed by the transport engine 325.

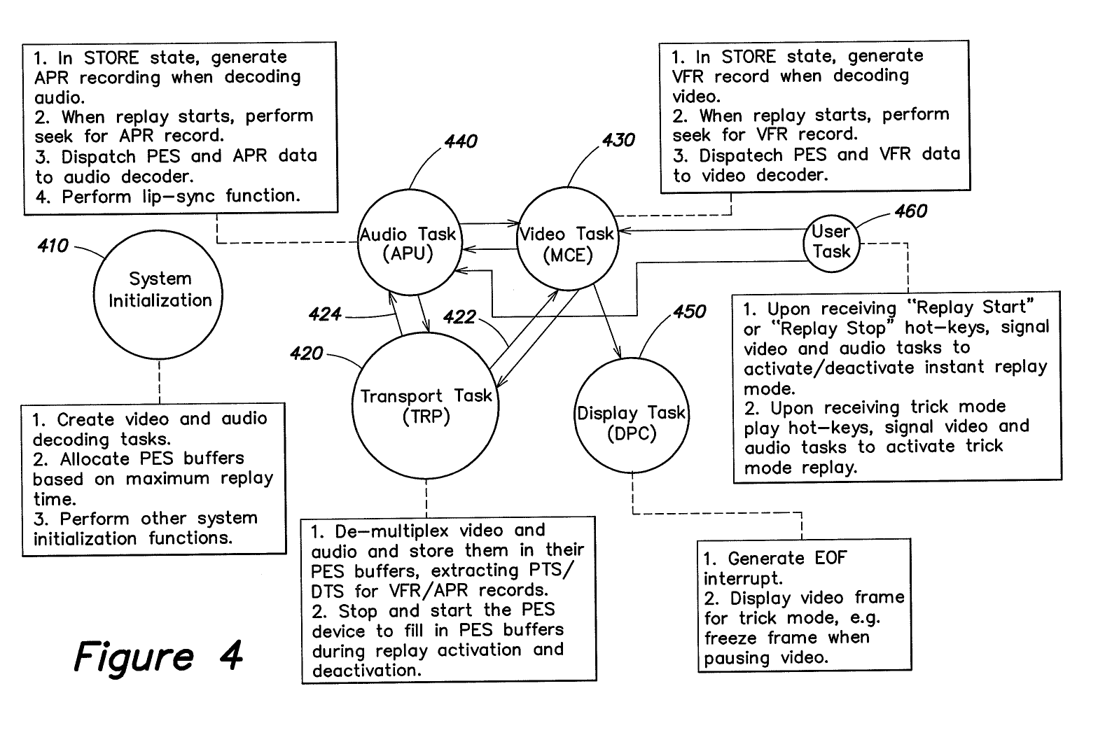

In accordance with one embodiment, the RF tuner 110, the switch 310, the DMA controller 315, the internal RAM memory 320, the transport engine 325, the video engine 330, the main CPU 335, the audio engine 340, the display engine 345, the memory interface 350 may be implemented on a single processor based circuit 305, such as the line of SupraHD® processors from Zoran Corporation of Sunnyvale Calif. The SupraHD® line of processors integrate a television system control processor with an MPEG-2 decoder, an 8VSB demodulator, NTSC video decoder, HDMI interface, low-voltage differential signaling (LVDS) drivers, memory, and other peripherals to provide a single-chip HDTV controller capable of driving various LCD panels. Although in one embodiment, the DDR memory 380 is implemented on a memory module that is separate from the single processor based circuit 305, it should be appreciated that in other embodiments, it may alternatively be implemented on the processor based circuit 305. FIG. 4 illustrates a task structure that may be implemented by the television system controller 300 in accordance with an embodiment of the present invention. As shown, the task structure 400 includes a system initialization task 410, a transport task 420, a video task 430, an audio task 440, a display task 450 and a user task 460. The system initialization task 410 may be performed by the main CPU 335 described previously with respect to FIG. 3, and includes creating the video and audio decoding tasks 430, 440, allocating memory 380 to form the video PES buffer 130, the VFR buffer 135, the audio PES buffer 140, the audio APR buffer 145 based upon the amount of DDR memory 380 provided and the desired maximum replay time to be supported. In accordance with one embodiment of the present invention, approximately five minutes of previously presented audio-video content may be replayed by the user. Where only audio content is to be replayed, such as from a digital music channel, the maximum replay time may be approximately 30 minutes or more. It should be appreciated that the amount of replay time may be increased by providing more memory. Other tasks that may be performed during the system initialization task 410 can include allocating a portion of the DDR memory 380 to store the Global Replay Control Data structure 280, and allocating portions of the DDR memory 380 for buffers 370 and 375 to store decompressed video and decompressed audio data prior to providing that data to the display engine 345 and the audio engine 340 for presentation to the user. The transport task 420 is implemented by the transport engine 325 and demultiplexes the TS packets provided by the RF tuner 110 and stores the separated video and audio PES packets in the video PES buffer 130 and the audio PES buffer 140, respectively. In the STORE state, the transport task 420 also extracts information from the video and audio PES packets, such as the Decoding Time Stamps (DTS) and/or the Presentation Time Stamps (PTS) to be stored in the VFR and APR corresponding to each video and audio PES packet. This information is provided to the video task 430 and the audio task 440, as indicated by arrows 422 and 424, respectively. During the SEEK and RETRIEVE states, the transport task no longer demultiplexes and stores the demodulated TS packets provided by the RF tuner 110, and the video and audio PES buffers 130, 140 and the VFR and APR buffers 135, 145 are maintained in their current state. This permits the video and/or audio content stored in the video and audio PES buffers 135, 145 to be replayed as many times as desired. When normal operation or the STORE state is resumed, the transport task 420 resumes demultiplexing the TS packets at the next available point in the TS (e.g., at the next available I-frame).

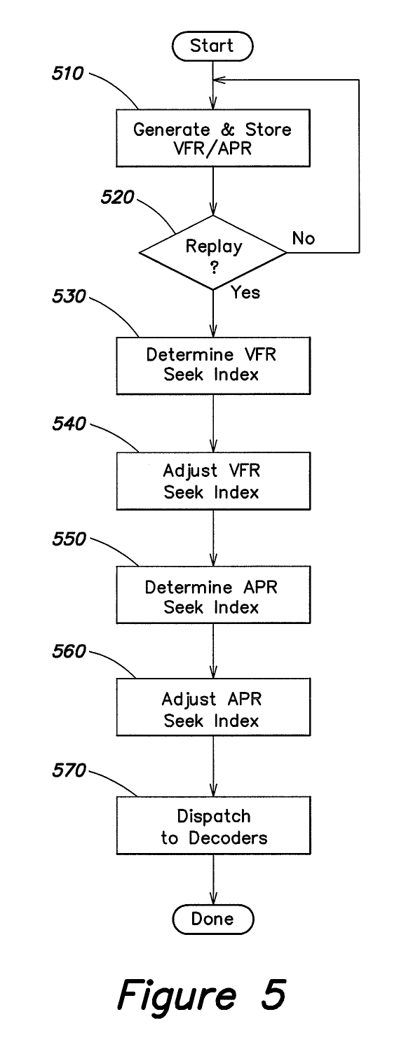

The video task 430 is implemented by the video engine 330. In a normal mode of operation (e.g., when the replay mode is not being used) the video task 430 operates in a conventional manner decoding video PES packets and providing them to the display task 450. In the STORE state, the video task 430 additionally generates the VFR corresponding to the video PES packet it is decoding as part of the decoding process. During the SEEK mode of operation, the video task 430 performs a search for the VFR corresponding most closely to the frame the user wishes to replay, as described more fully with respect to FIG. 5. During the RETRIEVE mode of operation, the video task 430 sends the VFR and its corresponding video PES packet to the video decoder 150 executing on the video engine 330.

The audio task 440 is implemented by the audio engine 340. In a normal mode of operation (e.g., when the replay mode is not being used) the audio task 440 operates in a conventional manner decoding audio PES packets and providing them to an audio DAC (not shown) which provides analog audio signals to an audio output device, such as one or more speakers associated with a display device. In the STORE state, the audio task 440 additionally generates the APR corresponding to the audio PES packet it is decoding as part of the decoding process. During the SEEK mode of operation, the audio task 440 performs a search for the APR corresponding most closely to the audio PES packet the user wishes to replay. As described more fully below, in one embodiment this is performed by comparing the amount of to time the user wishes to replay with the audio PES packet rate. During the RETRIEVE mode of operation, the audio task 440 sends the APR and its corresponding audio PES packet to the audio decoder 160 executing on the audio engine 340. During the RETRIEVE mode of operation, the audio task 440 also performs a lip-sync function to further adjust the timing of the presentation of audio content to that of a corresponding video frame, based upon a comparison of time stamps contained in the APR and VFR, and the propagation delays of the video and audio decoders 150, 160, as described more fully below.

The display task 450 is implemented by the display engine 345. In a normal mode of operation (e.g., when the replay mode is not being used) the display task 450 receives the decoded video content and provides pixel data and pixel timing and control information to a display in accordance with the requirements of the particular display (e.g., LCD, plasma, etc.) being used. For example, the pixel data and pixel timing and control information may be provided to a timing controller in accordance with the LVDS (Low Voltage Differential Signal) standard, or may be provided directly to the display in accordance with another standardized type of differential signaling, such as mini-LVDS or RSDS (Reduced Swing Differential Signaling). In the normal mode of operation, the display task also generates the end of field (EOF) interrupt to signal the end of a field of video frame. The display task 450 is also responsible for the timing and control to display a single frame of video content during trick modes, such as freeze frame or pause.

The user task 460 is implemented by the main CPU 335 and is responsible for interfacing with the user via an input device, such as a television remote control. In response to receiving a key press associated to a “Replay Start” command or a “Replay Stop” command from the remote control, the user task 450 signals the video and audio tasks to activate or deactivate the replay mode. In response to receiving a trick mode command, the user task signals the video and audio tasks 430, 440 to activate trick mode.

FIG. 5 is a flow chart depicting acts that are performed during the replay mode of operation by an instant replay routine in accordance with an embodiment of the present invention. In response to activation of the replay mode of operation, and in addition to the normal video and audio decoding process, a VFR is generated and stored in the circular VFR buffer 135 for each frame of a video PES packet that is to be decoded and an APR is generated and stored in the circular APR buffer 145 for each audio packet that is to be decoded in act 510. Each VFR is indexed in the VFR buffer 135 by its Current Frame Index 211, which is a to pointer maintained by the Video Control Data structure 210. Similarly, each APR is indexed in the APR buffer 145 by its Current Packet Index 251, which is a pointer maintained by the Audio Control Data structure 250. Information that may be included in each VFR and APR includes that information previously described with respect to FIG. 2.

In act 520 a determination is made as to whether the user has indicated a desire to replay previously presented content (audio, video, or audio and video). This may be determined, for example, in response to the user pressing a particular button (e.g., a “hot key”) associated with a remote control of the television system and indentifying the number of minutes or seconds they would like to replay. Where the user has not indicated a desire to replay previously presented content, the replay mode may return to act 510 and continue generating and storing VFRs and APRs associated with the video and audio content being decoded and presented. Alternatively, in response to a determination that the user would like to replay some previously presented content, the routine proceeds to act 530.

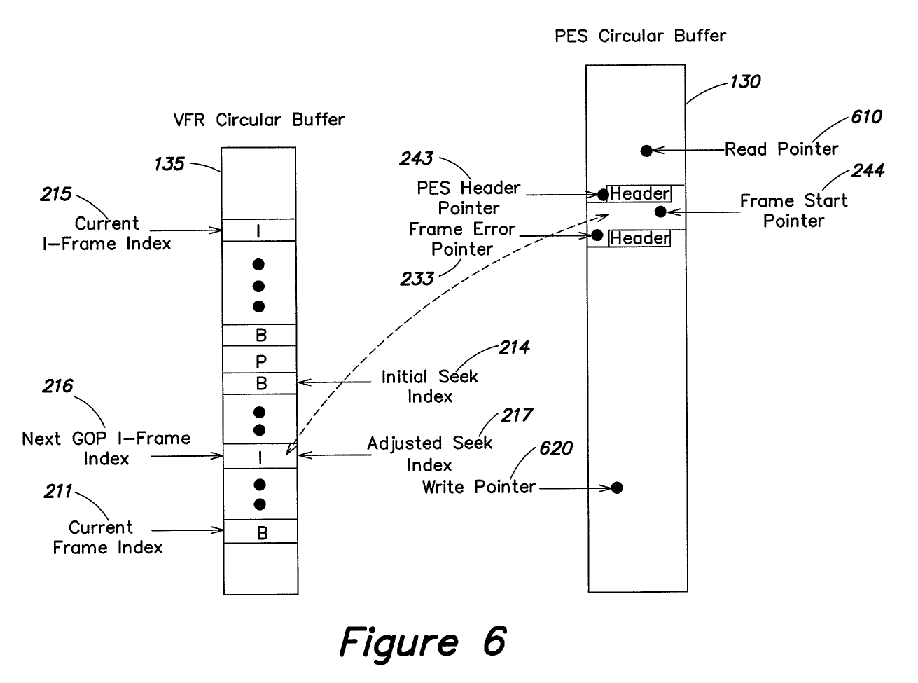

In act 530, the instant replay routine determines an Initial Seek Index 214 corresponding to an initial or starting position of the video frame to be replayed, based upon the indices of the VFRs. In accordance with one embodiment of the present invention, the Initial Seek Index 214 may be calculated based upon the Current Frame Index 211, the number of seconds that the user wishes to replay (e.g., the Replay Time 282), and the frame rate of the video content. For example, if the frame rate is 30 Hz and the user desires to go back 20 seconds, the Initial Seek Index could be calculated as the Current Frame Index minus 600. Should it be determined that the Initial Seek Index 214 is less than the Seek Start Index 212, the user may be prompted to enter a new replay time, or the Initial Seek Index 214 may be set to the Seek Start Index 212. The routine then proceeds to act 540 wherein an Adjusted Seek Index 217 is determined In accordance with an embodiment of the present invention and as described more fully with respect to FIG. 6 below, in act 540 the Initial Seek Index 214 is adjusted so that the video decoding process begins on an I-Frame. For example, if the Initial Seek Index 214 were to correspond to a previously presented P-frame, the Initial Seek Index value could be adjusted to that of the nearest I-frame, either the previously presented I-frame upon which the P-frame is based (i.e., the index contained in the Current I-Frame Index 215), or to the next I-frame (i.e., the index contained in the Next GOP I-Frame Index 216), dependent upon which is closer, and whether one or the other contains an error (e.g. where the PES Buffer Error Pointer 233 for that I-frame is other than a null value). In the event that the Initial Seek Index corresponds to an I-Frame, then act 540 may be omitted. In response to to determining the Adjusted Seek Index 217 of the nearest I-frame, the routine proceeds to act 550 wherein an APR Seek Index is determined.

In act 550, the routine determines a Seek STC value 256 based upon the number of seconds that the user wishes to replay and the audio packet rate. The Seek STC value 256 is then used to determine the index of the APR corresponding most closely to this STC value. In act 560, the index value of the APR previously determined in act 550 is adjusted by comparing time stamp (e.g., DTS/PTS) values stored in the VFR corresponding to the Adjusted VFR Seek Index 217 to those of the APR determined in act 550. For example, where the times stamps stored in the VFR corresponding to the Adjusted VFR Seek Index 217 are later in time than those of the APR determined in act 550, the index of the APR is incremented to correspond to the next APR.

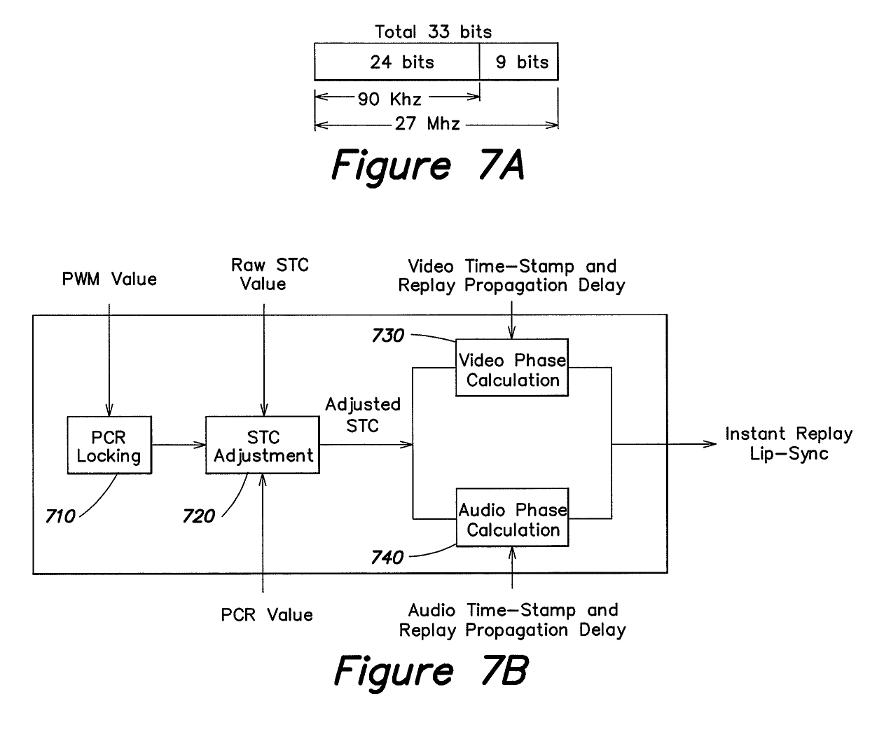

In act 570 the routine accesses the VFR corresponding to the Adjusted Seek Index 217 and sends the VFR data obtained from that VFR along with its corresponding video PES packet to the video decoder 150 for decoding. The routine also accesses the APR corresponding to the Adjusted APR Index determined in act 560 and sends the APR data obtained form that APR along with its corresponding audio PES packet to the audio decoder 160 for decoding. During act 570, the time stamps associated with the VFR are again compared to those of the APR to synchronize the audio content to the video content, based upon the known propagation delays introduced by the audio and video decoders. This adjustment, which may be based on the Adjusted STC of the decoder, may be stored as Video and Audio Lip-Sync Information 285 in the Global Replay Control Data Structure 280. Thus, for example, depending upon the value of the time stamps and the actual propagation delays of the audio and video decoders, the APR data and its corresponding audio PES packet may be sent to the audio decoder 160 some time after the VFR data and its corresponding video PES packet are sent to the video decoder 150 to ensure synchronization at the output of the television display device, as described more fully with respect to FIGS. 7a and 7b below. During a normal replay mode, after dispatching the VFR and APR data and the corresponding video and audio PES packets to the decoders, the indices for the VFR and APR would be incremented to reflect the next frame and audio packet, and the PES packets corresponding to those records would be sent, along with the corresponding VFR and APR data, to the respective video and audio decoders 150, 160 for decoding and display.

FIG. 6 graphically illustrates the manner in which VFR records and video PES packets are identified during the replay process in accordance with an embodiment of the to present invention. As previously described, the video PES buffer 130 is implemented as a circular buffer that includes a plurality of PES packets. Each PES packet includes a PES header, an optional PES header which may include indicators of whether DTS and/or PTS are present, and video frame data. Typically only a single frame of video data is included in each video PES packet (and similarly, typically only a single audio packet is included in each audio PES packet). Where more than one frame is included in a video or audio PES packet, each frame (or audio packet) would have a corresponding VFR (or APR).

The video PES packets are stored in a circular manner in the video PES buffer 130, such that the oldest video PES packets are shown at the top of the PES buffer 130 in FIG. 6, and the newest video PES packets at the bottom. A read pointer 610 identifies the location of the video PES packet being provided to the video decoder 150 and a write pointer 620 identifies the location of the video PES packet currently being stored in the video PES buffer after demultiplexing by the transport demultiplexer 120. The write pointer 610 may be copied into the VFR corresponding to this video PES packet as PES Buffer Read Pointer 232 (see FIG. 2). As shown in FIG. 6, a PES Header pointer 243 points to the location of the PES header for a particular video PES packet, a Frame Start Pointer 244 points to the location of the start of a frame of video data, and a Frame Error Pointer 233 points to the location of the first error identified in the frame of video data, if any. If no errors are present, the Frame Error Pointer 233 for this frame of video data is null.

During the SEEK mode of operation (acts 530-530 in FIG. 5) an Initial Seek Index 214 is calculated based upon the Current Frame Index 211 (i.e., the frame index of the frame associated with the PES packet currently being stored in video PES buffer and associated with the Write Pointer 610), the number of seconds that the user wishes to replay (e.g., the Replay Time 282), and the frame rate of the video content. As depicted in the example of FIG. 6, the Initial Seek Index 214 corresponds to a B-frame. Accordingly, an Adjusted Seek Index 217 is determined to find the closest I-frame. In the example of FIG. 6, where the index of the closest I-frame to the B-frame corresponding to the Initial Seek Index 214 is the I-frame of the next GOP I-frame, the Adjusted Seek Index 217 is adjusted to correspond to the Next GOP-I-Frame Index 216. If there were an error associated with this I-frame, the Adjusted Seek Index 217 would be adjusted to correspond to the Current I-Frame Index 215 (the index of the current GOP starting I-frame that includes the Initial Seek Index 214).

FIGS. 7a and 7b illustrate the manner in which the decoding and presentation of audio data may be synchronized to the decoding and presentation of video data in accordance with an to embodiment of the present invention. The STC of the encoder that generates the encoded video and audio content is encoded in the transport stream (TS) based upon a 27 MHz clock. As illustrated in FIG. 7a, the System Time Clock (STC) of the decoder may be represented as a 33 bit counter where the first 24 bits represent the 90 KHz clock used to compare with DTS and PTS, and where the full 33 bits represent the 27 MHz clock. The frequency of the STC of the decoders is matched to the frequency of the STC of the encoder by a PCR Locking stage 710 based upon the output of a Pulse Width Modulator (PWM) and the Program Clock Reference (PCR) as shown in FIG. 7b. The PWM value is used to adjust a voltage controlled crystal oscillator (VCXO), not shown, to match the frequency of the encoder STC. The Raw STC value of the 33 bit counter of the decoders, which may differ from the STC of the encoder, is then adjusted by an STC Adjustment stage 720 based upon the PCR value and converted to the 90 KHz domain to provide an Adjusted STC value. This Adjusted STC value is provided to a Video Phase Calculation stage 730 and an Audio Phase Calculation stage 740. The Video Phase Calculation stage 730 receives a video time stamp, such as DTS and/or PTS for a given frame and a known propagation delay value of the video decoder 150 to generate a video phase value indicative of when that frame will be decoded. The Audio Phase Calculation stage 740 receives an audio time stamp, such as DTS and/or PTS for a given audio packet and a known propagation delay value of the audio decoder 160 to generate an audio phase value indicative of when that audio packet will be decoded. The difference between the video phase value and the audio phase value corresponds to the difference in time between when the video PES packet should be sent to the video decoder 150 to decode that frame and when the audio PES packet should be sent to the audio decoder 160 to decode that audio packet. This Video and Audio Lip- Sync Information value may be used to ensure that the decoded audio content matches the decoded video content on a lip-sync basis in act 570 of FIG. 5.

As previously discussed, embodiments of the present invention may support a number of “trick” modes, such as such as fast forward, slow forward, stop/pause, fast backward, slow backward, single-step forward, single-step backward, etc. For example, a fast forward mode of replay can be provided by locating the VFR record of each I-frame after that of the Adjusted Seek Index 217 (FIG. 2) and sending the video PES packet corresponding to that I-frame and the VFR data of its corresponding VFR to the video decoder 150 for decoding. During the fast forward mode, only video PES packets would need to be decoded, as the corresponding audio to data would be unpleasant if presented. Alternatively, the corresponding audio PES packets could be decoded, but the audio content could be muted based upon whether the value of the Audio Mute field 258 (FIG. 2) in the Audio Control Data structure 250 indicated that audio should be muted. During a slow forward mode, in addition to decoding each I-frame after that of the Adjusted Seek Index, every P-frame or every other P-frame could be decoded and presented. During a stop or pause mode, the display processor 170 can be instructed by the main CPU 335 to simply replay the current frame. During a single step forward mode, each video frame stored in the video PES buffer 130 would be identified and decoded as in the normal replay mode of operation, but the display processor 170 would be instructed to replay the each frame of video content a number of times before displaying the next frame.

During the fast backward mode of operation, the VFR record corresponding to each I-frame prior in time to the current frame (i.e., as identified based on the Current Frame Index 211) could be identified and the VFR data and the corresponding video PES packet sent to the video decoder 150 in the reverse of their original frame order. During the slow backward mode of operation, and in addition to identifying and decoding each I-frame prior to the current frame, a single P-frame, each P-frame, or every other P frame could additionally be identified and sent along with its corresponding VFR data to the video decoder 150. During this mode of operation, the I-frame from which each P-frame was predicted would be sent to the video decoder 150 and the decoded frame of video data stored in the video replay decompressed buffer 370 (FIG. 3), and then the associated P-frame(s) would be sent to the video decoder. Where only a single P-frame is to be displayed, the P-frame would be provided to the display processor 170, followed by the preceding I-frame that was stored in the video replay decompressed buffer 370. Where each P-frame is to be displayed, the most recent P-frame prior to the current frame would be provided to the display processor 170, with earlier P-frames and the I-frame from which they were predicted being stored in the video replay decompressed buffer 370 and sent to the display process in the reverse of their original frame order.

The single step backward mode of operation will necessarily depend upon the frame type and order of the compressed video content. For example, if the immediately preceding frame prior to the Current Frame Index 211 were a B-frame, then the I-frame from that Group of Pictures (GOP) would first be decoded and stored in the video replay decompressed buffer, followed by the decoding and storage of each P-frame (in the original frame order) from that GOP. The B-frame would then be decoded and displayed, followed by the decoding and to display of any prior B-frames (in reverse order) between the first displayed B-frame and the immediately preceding P-frame (in the original frame order). The previously decoded P-frame would then be retrieved from the video replay decompressed buffer 370 and provided to the display processor 170.

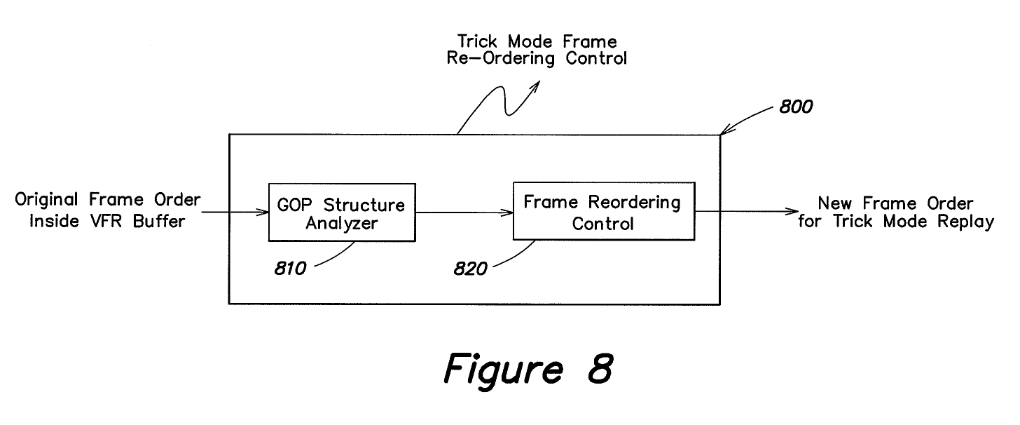

It should be appreciated that the frame reordering needed to support the various trick modes of operation will be based upon an analysis of the actual order of I, P, and B frames in each GOP. This may be performed by logic associated with the television system controller as depicted in FIG. 8. As depicted in FIG. 8, a trick mode control unit 800 may include a GOP Structure Analyzer 810 and a Frame Re-ordering Control unit 820. In response to a user's indicated desire to replay video and audio content stored in the video and audio PES buffers, the indices of the corresponding VFR records and their associated Picture Type field may be provided to the GOP Structure Analyzer 810. The GOP Structure Analyzer 810 analyzes the order of the I, P, and B frames to determine an order in which the frames would normally be provided to the video decoder 150 and provides this to the Frame Re-ordering Control unit 820. Dependent upon the trick mode selected, the Frame Re-ordering Control unit re-orders the frames so that they may be decoded and displayed in the correct order.

It should be appreciated that embodiments of the present invention provide the ability to replay video and/or audio content that has previously been presented, in the order in which it was previously presented, or in a number of different trick modes. Unlike conventional replay implementations which utilize separate hardware such as a hard disk or an in-memory playback unit and store transport stream TS packets, embodiments of the present invention instead utilize the demultiplexed video and audio PES packets, thereby obviating the need to demultiplex the TS packets again. Further, because embodiments of the present invention utilize the existing video and audio PES buffer 130, 140 to store video and audio content for playback, little additional memory is required, other than the relatively small amount of memory used to store the VFRs and APRs. In accordance with one embodiment, the amount of additional memory used to store the VFRs and APRs is approximately 105 Kbytes for each minute of audio-video content that can be replayed (e.g. (60 seconds of replay)*(30 frame per second)*(60 bytes combined for one VFR and one APR)). In a conventional DVR that supports replay functionality by storing video and audio PES packets in files on an associated disk, it would take approximately 75 Mbytes for each minute of audio-video content to be replayed. In addition, unlike conventional DVRs or PVRs which typically require a complicated set-up or programming process, previously displayed video and/or audio content to may be replayed nearly instantaneously by simply activating the replay mode at the touch of a button on a remote control, and without going through a complicated file navigation process to locate previously recorded content.

Although embodiments of the present invention have been described primarily in terms of replaying video content or video and audio content, it should be appreciated that embodiments of the present invention may also be used with only audio content. Where audio content alone is to be replayed to the user (in the form that such audio content is typically found on a digital audio channel, such as musical channel), the user may be provided with an ability to select the language in which the audio content is re-presented.

Having now described some illustrative aspects of the invention, it should be apparent to those skilled in the art that the foregoing is merely illustrative and not limiting, having been presented by way of example only. Numerous modifications and other illustrative embodiments are within the scope of one of ordinary skill in the art and are contemplated as falling within the scope of the invention.

What is claimed is:

1. A method of processing a broadcast signal that includes at least one of audio data and video data, comprising acts of:
demodulating the broadcast signal to provide transport stream packets corresponding to the broadcast signal;
demultiplexing the transport stream packets to provide a plurality of packetized elementary stream packets and decoding and presentation timing information corresponding to each of the plurality of packetized elementary stream packets;
storing the plurality of packetized elementary stream packets in a volatile memory;
decoding the plurality of packetized elementary stream packets stored in the volatile memory based upon the decoding timing information;
presenting the decoded plurality of packetized elementary stream packets on a display device based upon the presentation timing information;
generating a plurality of records corresponding to each of the plurality of packetized elementary stream packets and storing the plurality of records in the volatile memory, each of the plurality of records identifying a location of a respective one of the plurality of packetized elementary stream packets stored in the volatile memory and the decoding and presentation timing information corresponding to the respective one of the plurality of packetized elementary stream packets;
locating a first of the plurality of packetized elementary stream packets stored in the volatile memory based upon an instruction to replay at least one of the plurality of packetized elementary stream packets stored in the volatile memory;
decoding, subsequent to the act of presenting, the first of the plurality of packetized elementary stream packets stored in the volatile memory based upon the record corresponding to the first of the plurality of packetized elementary stream packets, the first of the plurality of elementary stream packets, and the decoding timing information corresponding to the first of the plurality of packetized elementary stream packets; and
re-presenting the decoded first of the plurality of packetized elementary stream packets on the display device based upon the presentation timing information corresponding to the first of the plurality of packetized elementary stream packets.

2. The method of claim 1, wherein the broadcast signal includes both audio and video data, and wherein the act of demutliplexing includes:
demultiplexing the transport stream packets to provide a plurality of video packetized elementary stream packets and decoding and presentation timing information corresponding each of the plurality of video packetized elementary stream packets and to provide a plurality of audio packetized audio packetized elementary stream packets and decoding and presentation timing information corresponding each of the plurality of audio packetized elementary stream packets.

3. The method of claim 2, wherein the act of generating includes acts of:
generating a plurality of video records corresponding to each of the plurality of video packetized elementary stream packets and storing the plurality of video records in the volatile memory, each of the plurality of video records identifying a location of a respective one of the plurality of video packetized elementary stream packets stored in the volatile memory and the decoding and presentation timing information corresponding to the respective one of the plurality of video packetized elementary stream packets; and
generating a plurality of audio records corresponding to each of the plurality of audio packetized elementary stream packets and storing the plurality of audio records in the volatile memory, each of the plurality of audio records identifying a location of a respective one of the plurality of audio packetized elementary stream packets stored in the volatile memory and the decoding and presentation timing information corresponding to the respective one of the plurality of audio packetized elementary stream packets.

4. The method of claim 3, wherein the act of generating the plurality of video records includes:
determining a picture type of each respective video packetized elementary stream packet of the plurality of video packetized elementary stream packets; and
storing the picture type in the video record corresponding to the respective video packetized elementary stream packet.

5. The method of claim 4, wherein the act of generating the plurality of video records further includes:
determining a number of decoded data bytes of each respective video packetized elementary stream packet of the plurality of video packetized elementary stream packets; and
storing the number of decoded data bytes in the video record corresponding to the respective video packetized elementary stream packet.

6. The method of claim 5, wherein the act of locating includes an act of locating one of the plurality of video packetized elementary stream packets stored in the volatile memory based upon the instruction to replay the at least one of the plurality of packetized elementary stream packets stored in the volatile memory, a replay time, and a frame rate of the video data.

7. The method of claim 6, wherein the act of locating the one of the plurality of video packetized elementary stream packets stored in the volatile memory based upon the instruction to replay the at least one of the plurality of packetized elementary stream packets stored in the volatile memory, the replay time, and the frame rate of the video data includes acts of:
determining whether the video record corresponding to the one of the plurality of video packetized elementary stream packets includes an I-frame picture type;
selecting, responsive to a determination that the one of the plurality of video packetized elementary stream packets includes an I-frame picture type, the one of the plurality of video packetized elementary stream packets as the first of the plurality of packetized elementary stream packets to decode;
locating, responsive to a determination that the video record corresponding to the one of the plurality of video packetized elementary stream packets does not include an I-frame picture type, a nearest video packetized elementary stream packet that does include an I-frame picture type; and
selecting the nearest video packetized elementary stream packet that does include an I-frame picture type as the first of the plurality of packetized elementary stream packets to decode.

8. The method of claim 7, wherein the act of generating the plurality of audio records includes:
determining a number of decoded data bytes of each respective audio packetized elementary stream packet of the plurality of audio packetized elementary stream packets; and
storing the number of decoded data bytes in the audio record corresponding to the respective audio packetized elementary stream packet.

9. The method of claim 8, further comprising an act of
locating one of the plurality of audio packetized elementary stream packets stored in the volatile memory based upon the instruction to replay the at least one of the plurality of packetized elementary stream packets stored in the volatile memory, a replay time, and an audio packet rate of the audio data.

10. The method of claim 9, further comprising acts of:
determining whether the decoding timing information of the audio record corresponding to the one of the plurality of audio packetized elementary stream packets corresponds to the decoding timing information of the video record corresponding to the selected first of the plurality of packetized elementary stream packets; and
selecting, responsive to a determination that the decoding timing information of the audio record corresponding to the one of the plurality of audio packetized elementary stream packets corresponds to the decoding timing information of the video record corresponding to the selected first of the plurality of packetized elementary stream packets, the one of the plurality of audio packetized elementary stream packets to decode.

11. The method of claim 10, further comprising act of:
sending the one of the plurality of audio packetized elementary stream packets to an audio decoder;
decoding the one of the plurality of audio packetized elementary stream packets based upon the decoding timing information of the audio record corresponding to the one of the plurality of audio packetized elementary stream packets and the one of the plurality of audio packetized elementary stream packets; and
re-presenting the decoded one of the plurality of audio packetized elementary stream packets on the display device along with the decoded first of the plurality of packetized elementary stream packets based upon the presentation timing information corresponding to the one of the plurality of audio packetized elementary stream packets.

12. The method of claim 11, wherein the act of decoding the first of the plurality of packetized elementary stream packets is performed by a video decoder, the method further comprising acts of:
determining a propagation delay of the video decoder; and
determining a propagation delay of the audio decoder;
wherein a time at which the act of sending the one of the plurality of audio packetized elementary stream packets to an audio decoder is performed is adjusted based upon the propagation delay of the video decoder, the propagation delay of the audio decoder, and a difference between the decoding timing information of the audio record corresponding to the one of the plurality of audio packetized elementary stream packets and the decoding timing information corresponding to the first of the plurality of packetized elementary stream packets to synchronize re-presentation of the decoded one of the plurality of audio packets with the decoded first of the plurality of packetized elementary stream packets.

13. A digital television system, comprising:
an RF tuner to receive a broadcast signal, demodulate broadcast signal, and provide transport stream packets corresponding to the broadcast signal;
a transport stream demultiplexer, coupled to the RF tuner, to receive the transport stream packets, demultiplex the transport stream packets and provide a plurality of packetized elementary stream packets and decoding and presentation timing information corresponding to each of the plurality of packetized elementary stream packets;
a non-persistent memory, coupled to the transport stream demultiplexer, the non-persistent memory having a plurality of memory regions, the plurality of regions including a first memory region configured to store the plurality of packetized elementary stream packets, and a second memory region configured to store a plurality of records corresponding to each of the plurality of packetized elementary stream packets;
at least one decoder, coupled to transport stream demultiplexer and the non-persistent memory, to decode the plurality of packetized elementary stream packets according to the decoding timing information corresponding to each of the plurality of packetized elementary stream packets;
a display device to present the plurality of decoded packetized elementary stream packets according to the presentation timing information corresponding to each of the plurality of decoded packetized elementary stream packets; and
at least one processor, coupled to the non-persistent memory and the at least one decoder, the at least one processor executing a set of instructions configured to:
generate the plurality of records corresponding to each of the plurality of packetized elementary stream packets, each of the plurality of records identifying a location of a respective one of the plurality of packetized elementary stream packets stored in the first memory region and the decoding and presentation timing information corresponding to the respective one of the plurality of packetized elementary stream packets;
locate a first of the plurality of packetized elementary stream packets stored in the first memory region and corresponding to a previously decoded and displayed packetized elementary stream packet responsive to an instruction to replay at least one of the plurality of packetized elementary stream packets;
decode the first of the plurality of packetized elementary stream packets based upon the record corresponding to the first of the plurality of packetized elementary stream packets, the first of the plurality of packetized elementary stream packets, and the decoding timing information corresponding to the first of the plurality of packetized elementary stream packets; and
re-present the first of the decoded packetized elementary stream packets on the display device based upon the presentation timing information corresponding to the first of the plurality of packetized elementary stream packets.

14. The digital television system of claim 13, wherein:
the first memory region includes a video buffer region configured to store a plurality of video packetized elementary stream packets and an audio buffer region configured to store a plurality of audio packetized elementary stream packets; and
the second memory region includes a video record buffer region configured to store a plurality of video records corresponding to each of the plurality of video packetized elementary stream packets and an audio record buffer region configured to store a plurality of audio records corresponding to each of the plurality of audio packetized elementary stream packets, each video record of the plurality of video records identifying a location, in the video buffer region, where a respective one of the plurality of video packetized elementary stream packets is stored, and the decoding and presentation timing information corresponding to the respective one of the plurality of video packetized elementary stream packets, and each audio record of the plurality of audio records identifying a location, in the audio buffer region, where a respective one of the plurality of audio packetized elementary stream packets is stored, and the decoding and presentation timing information corresponding to the respective one of the plurality of audio packetized elementary stream packets.

15. The digital television system of claim 14, wherein the at least one decoder includes:
a video decoder, coupled to transport stream demultiplexer and the non-persistent memory, to decode the plurality of video packetized elementary stream packets according to the decoding timing information corresponding to each of the plurality of video packetized elementary stream packets; and
an audio decoder, coupled to transport stream demultiplexer and the non-persistent memory, to decode the plurality of audio packetized elementary stream packets according to the decoding timing information corresponding to each of the plurality of audio packetized elementary stream packets.

16. The digital television system of claim 15, wherein the at least one processor is further configured to:
determine a picture type of each respective video packetized elementary stream packet of the plurality of video packetized elementary stream packets;
determine a number of decoded data bytes of each respective video packetized elementary stream packet of the plurality of video packetized elementary stream packets; and
store the picture type and the number of decoded data bytes in the video record corresponding to the respective video packetized elementary stream packet.

17. The digital television system of claim 16, wherein the at least one processor is further configured to:
determine a number of decoded data bytes of each respective audio packetized elementary stream packet of the plurality of audio packetized elementary stream packets; and
store the number of decoded data bytes in the audio record corresponding to the respective audio packetized elementary stream packet.

18. The digital television system of claim 17, further comprising:
a display processor, coupled to the video decoder and the display device, to display the plurality of decoded video packetized elementary stream packets on the display device; and
an audio digital to analog converter, coupled to the audio decoder and the display device, to convert the plurality of decoded audio packetized elementary stream packets to an analog format for presentation on an audio output device associated with the display device.

19. The digital television system of claim 18, wherein the RF tuner, the transport stream demultiplexer, the non-persistent memory, the video decoder, the audio decoder, the display processor, the audio digital to analog converter, and the at least one processor are to implemented on a same integrated circuit.
